(19) United States
(12) Patent Application Publication
(10) Pub. No.: US 2022/0132924 A1
(43) Pub. Date: May 5, 2022

(54) MULTI-SESSION PERSONAL VAPORIZER DEVICES, SUPPLY CARTRIDGES THEREFOR, AND CARTRIDGE FILLING SYSTEM

(71) Applicant: Fawn Industries, Inc., Hunt Valley, MD (US)

(72) Inventors: Leo KAHL, Bel Air, MD (US); Nicholas FLOWER, Minneapolis, MN (US); Raymond H. FIORAVANTE, Kingsville, MD (US)

(21) Appl. No.: 17/433,592

(22) PCT Filed: Feb. 25, 2020
(86) PCT No.: PCT/US2020/019716

§ 371 Date: Aug. 24, 2021

Related U.S. Application Data
(60) Provisional application No. 62/809,913, filed on Feb. 25, 2019.

(51) Int. Cl. A24F 40/42; A24F 40/46; A24F 40/20; A24F 40/485; A24F 7/00; A24F 40/57; F16K 3/24

(52) U.S. Cl. CPC A24F 40/42; A24F 40/46; A24F 40/20; H05B 3/06; A24F 7/00; A24F 40/57; F16K 3/24; A24F 40/485

(57) ABSTRACT

A personal vaporization device for use with non-liquid vaporizable material, such as ground herbal material, is designed to provide for multiple vaporizing sessions with a single loading of the of the device. The device comprises an oven assembly including an oven for holding material for a single vaporizing session, and an electric heating element thermally coupled to the oven to heat the material in the oven. Vapors generated by the heated material travel through an air flow path for inhalation by a user. A hopper holds a supply of the material for at least one additional session, and the oven is resupplied for a new session by feeding material from the hopper via a flow path to the oven. The hopper can be designed to receive the vaporizable material directly or to receive a cartridge containing the supply of vaporizable material. A system for filling a plurality of cartridges is also provided.

### CROSS-REFERENCE TO RELATED APPLICATION

The present application claims the benefit of U.S. Provisional Application No. 62/809,913, filed Feb. 25, 2019, which is hereby incorporated by reference herein in its entirety.

### FIELD

The present disclosure relates generally to vaporizing botanicals, and more particularly, to personal vaporizer devices offering multiple vaporization sessions.

### BACKGROUND

In conventional portable/personal electronic vaporizer devices, a volume of vaporizable material is loaded into an oven (heating chamber) and is heated to generate vapors. A user inhales the vapors by sucking at an inlet end of the vaporization device, which pulls air through the oven. Once no further vapors can be extracted from the vaporizable material (i.e., a particular session of material), the user unloads the oven of the vaporized material to allow for a subsequent session, e.g., by cleaning the oven and reloading with a new volume of vaporizable material. As such, existing personal vaporizer devices only provide a single session per loading with vaporizable material. While some existing vaporizer devices allow for multiple session use without reloading, such vaporizer devices employ liquid materials (e.g., oils or extracts) rather than non-liquid herbal material (e.g., loose leaf tobacco or other botanicals, which may be ground or otherwise divided to improve vaporization efficiency).

Accordingly, there is a need for a personal vaporizer device capable of providing multiple vaporizer sessions from a single loading of the vaporizer device with herbal material.

Embodiments of the disclosed subject matter may address one or more of the above-needs, among other things.

### BRIEF DESCRIPTION OF DRAWINGS

Embodiments of the invention will hereinafter be described with reference to the accompanying drawings, which have not necessarily been drawn to scale. Where applicable, some elements may be simplified, have dimensions exaggerated, or otherwise not illustrated in order to assist in the illustration and description of underlying features. Throughout the figures, like reference numerals denote like elements.

FIG. 1 is an explanatory diagram illustrating aspects of a personal vaporization device.

FIGS. 2A-2C are front, side, and top (without cap) views, respectively, of a first embodiment of a personal vaporization device.

FIG. 2D shows an oven insert used in the personal vaporization device of the first embodiment.

FIGS. 2E-2F are isometric views of the personal vaporization device (without cap) of the first embodiment.

FIGS. 2G-2H show aspects of a hinged cap used in the personal vaporization device of the first embodiment.

FIG. 2I illustrates a feed operation for loading the oven of the personal vaporization device of the first embodiment.

FIGS. 3A-3C are explanatory diagrams illustrating feed, vape, and release positions, respectively, for a second embodiment of a personal vaporization device.

FIGS. 3D-3F are isometric views of the personal vaporization device of the second embodiment in feed, vape, and release positions, respectively.

FIGS. 3G-3I illustrate assembled and disassembled components of an exemplary cartridge for holding vaporizable material, which can be used with the personal vaporization device of the second embodiment, or any other disclosed embodiment.

FIG. 4A is an isometric view of a third embodiment of a personal vaporization device.

FIGS. 4B-4C are cross-sectional views of the personal vaporization device of the third embodiment during cartridge loading and vaporization operations, respectively.

FIGS. 4D-4F show aspects of a removable oven base used in the personal vaporization device of the third embodiment.

FIG. 4G shows aspects of a first variation for the removable oven base used in the personal vaporization device of the third embodiment.

FIGS. 4H-4J show aspects of a removable oven base for use in the personal vaporization device of the third and other embodiments.

FIGS. 4K-4L illustrate a cartridge for holding vaporizable material and an array of cartridges, respectively, which can be used with the personal vaporization device of the third and other embodiments.

FIG. 5A is a hidden-line side view of a fourth embodiment of a personal vaporization device.

FIG. 5B is a cross-sectional view illustrating interaction of a cartridge, feed valve, and oven assembly of the personal vaporization device of the fourth embodiment.

FIGS. 5C and 5E are isometric views of the personal vaporization device of the fourth embodiment.

FIG. 5D is an exploded view of the feed valve used in the personal vaporization device of the fourth embodiment.

FIG. 6A is a cross-sectional view of a fifth embodiment of a personal vaporization device.

FIGS. 6B-6C are isometric views of the personal vaporization device of the fifth embodiment.

FIG. 6D shows assembled and exploded views of the oven assembly used in the personal vaporization device of the fifth embodiment.

FIG. 6E illustrates cross-sectional arrangements of the oven assembly of FIG. 6D in feed, vape, and release positions.

FIG. 7A is a cross-sectional view of a sixth embodiment of a personal vaporization device.

FIGS. 7B-7C are isometric views of the personal vaporization device of the sixth embodiment.

FIG. 7D is a partially assembled view of the oven assembly used in the personal vaporization device of the sixth embodiment.

FIG. 7E illustrates cross-sectional arrangements of the oven assembly of FIG. 7D in feed, vape, and release positions.

FIG. 8A is a cross-sectional view of a seventh embodiment of a personal vaporization device.

FIG. 8B is an isometric view of the personal vaporization device of the seventh embodiment.

FIGS. 8C-8D are exploded and assembled views, respectively, of the oven assembly used in the personal vaporization device of the seventh embodiment.

FIG. 8E is an exploded isometric view of the personal vaporization device of the seventh embodiment.

FIG. 8F illustrates a variation for the body of the personal vaporization device of the seventh embodiment.

FIG. 9A is a cross-sectional view of an eighth embodiment of a personal vaporization device.

FIG. 9B illustrates cross-sectional arrangements of the oven assembly used in the personal vaporization device of the eighth embodiment.

FIG. 9C is an isometric view of the personal vaporization device of the eighth embodiment.

FIG. 9D illustrates cross-sectional arrangements of the oven assembly used in a variation of the personal variation device of the eighth embodiment.

FIGS. 10A-10F illustrate various embodiments for a cartridge to hold vaporizable material.

FIGS. 11A-11C illustrate side, exploded, and cross-sectional views of a cartridge with integrated feed mechanism according to a first embodiment.

FIGS. 12A-12D illustrate unfilled, uncapped, filled, and cross-sectional views, respectively, of a cartridge with integrated feed mechanism according to a second embodiment.

FIG. 13 illustrates aspects of a station for filling multiple cartridges with vaporizable material.

### DETAILED DESCRIPTION

Embodiments of the disclosed personal electronic vaporization device allow for multiple vaporizer sessions from a single loading, in particular, loading with a non-liquid herbal material that may be whole plant or ground (or otherwise divided). To provide a single session of vaporization, a portion of the loaded material is dispensed from within the vaporization device to an oven assembly for heating. The oven assembly of the vaporization device includes one or more movable components that support the loading/unloading of herbal material for a single session of vaporization.

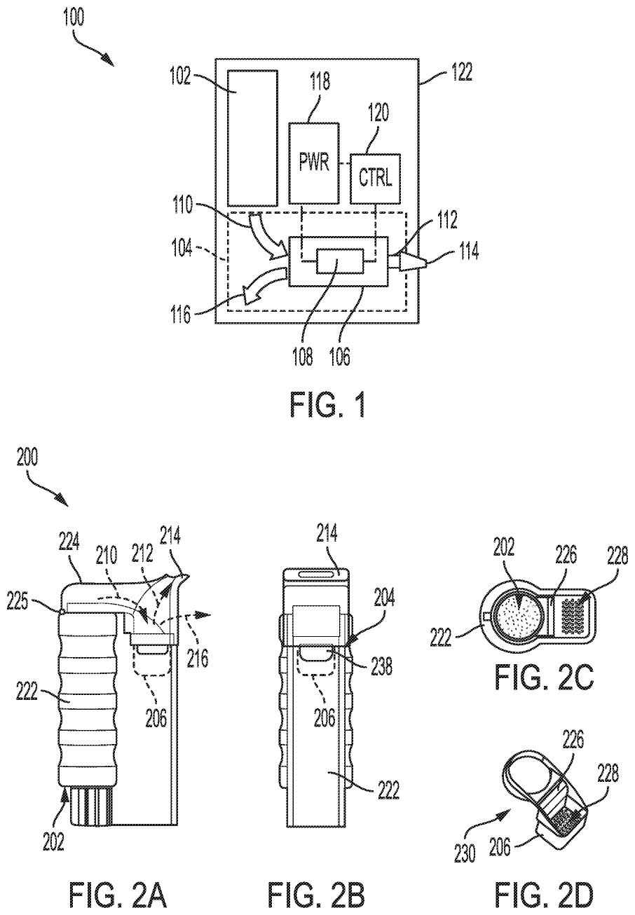

FIG. 1 illustrates aspects of a generalized personal electronic vaporization device 100 according to various embodiments. The personal vaporization device 100 has a hopper 102, an oven assembly 104, a power supply 118, and control electronics 120, all of which are housed within a common vaporizer body 122. The oven assembly 104 includes an oven 106 and an electric heating element 108. The oven 106 has an internal volume (first volume) that holds, for heating by the heating element 108, the vaporizable material for a session of use. The power supply 118 provides electrical power (e.g., DC voltage) to the control electronics 120 and electric heating element 108. The control electronics 120 control operation of the vaporization device 100, including, for example, temperature control of the electric heating element 108.

Prior to use, the hopper 102, which has an internal volume (second volume) preferably much larger than that of the oven 106, is loaded by a user with the vaporizable material. For example, the hopper 102 can have a volume at least as large, but preferably at least 3 times greater than that of the oven. Such loading can include depositing vaporizable material directly into the hopper 102 within the vaporizer body 122, or by loading a cartridge pre-filled with vaporizable material into the hopper 102. When a vaporization session is desired, a portion of the vaporizable material stored by hopper 102 is dispensed along a feed path 110 to the internal volume of the oven 106.

The vaporizable material within oven 106 is heated by heating element 108, thereby generating vapors that can be extracted via inhalation flow path 112 by the user sucking on mouthpiece 114. During the session, the remaining vaporizable material is retained in the hopper 102 and is thermally isolated from the oven 106, thereby preserving the remaining material for subsequent sessions. Once the vaporizable material in the oven 106 is expended (i.e., no further vapors are generated by further heating), the contents in the internal volume of the oven 106 can be removed via discharge path 116.

The oven assembly 104 includes one or more movable elements that controls access to feed path 110 and discharge path 116 to facilitate loading from hopper 102, isolation of the hopper 102 during vaporization of a particular session, and discharge from the oven 106. Such movable elements include, but are not limited to, a valve that opens/closes the feed path (or loading path), a valve that opens/closes the discharge path, a portion of the oven that moves to open/close the feed/discharge paths, an oven sleeve that moves to open/close the feed/discharge paths, and the entire oven that moves to open/close the feed/discharge paths. Embodiments addressing such variations are discussed in further detail below.

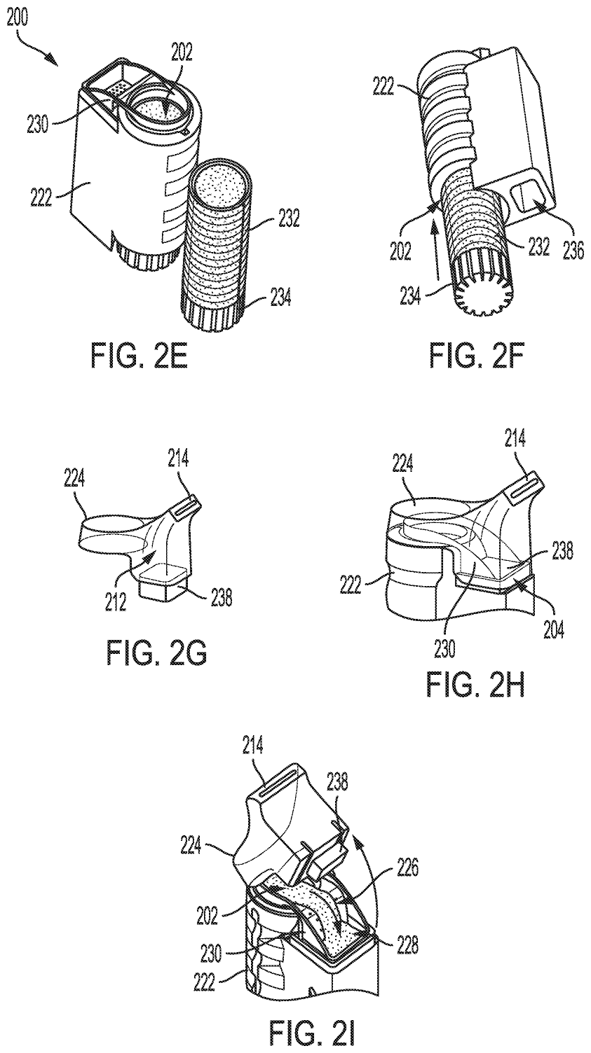

Referring to FIGS. 2A-2I, a first embodiment of a personal vaporization device 200 is shown. The personal vaporization device 200 has a cap 224, hinged to the vaporizer body 222 at one end (e.g., at 225) that allows the cap 224 to rotate from a feed/discharge position (FIG. 2I) to a vape position (FIGS. 2A-2B, 2H). The cap 224 includes a perforated metal part 238 (e.g., a block with flow paths extending therethrough or a hollow shell with perforations) that forms a top wall for oven 206 when the cap 224 is in the vape position. Other walls of the oven 206 are defined by metal insert 230, which includes at least a perforated bottom wall, as shown in FIGS. 2C-2D. A heating element can be attached to one or more external surfaces of the insert 230, for example, wrapped around the side walls of the insert defining volume 228, in order to heat vaporizable material therein.

The volume 228 of the oven 206, which is to be filled with vaporizable material, is thus defined between the metal part 238 of cap 224 and the perforated bottom wall of insert 230. Thus, oven 206 and the cap 224 form parts of an oven assembly 204, where at least the metal part 238 of cap 224 is movable. In particular, the metal part 238 can move between a first position at or within the oven 206 (i.e., vaporization position), where the metal part 238 pushes on and compacts vaporizable material in volume 228, and a second position displaced from the oven 206 (i.e., feed/discharge or loading/removal position) to allow ingress/egress of vaporizable material into/from the volume 228. The cap 224 also has a portion that defines the user mouthpiece 214 as well as internal walls that define material and vapor pathways within the cap 224.

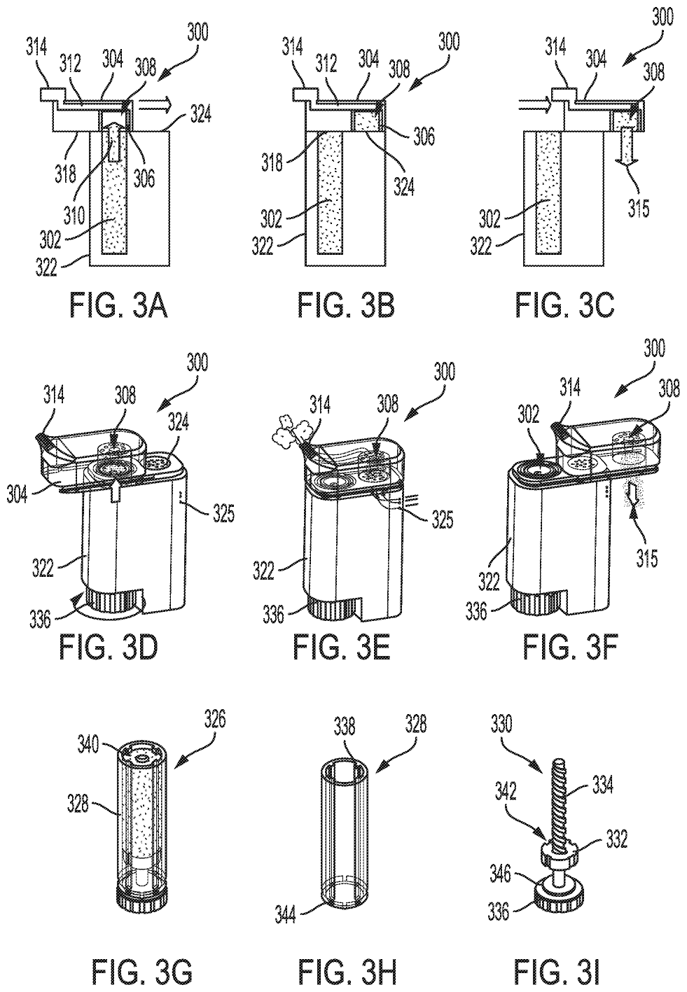

Hopper 202 stores a volume of vaporizable material for multiple sessions. For example, a cartridge 232 containing a premeasured supply of vaporizable material can be inserted into the hopper 202. The cartridge 232 can have a translating element actuated by manual rotation of knob 234, which displaces vaporizable material within cartridge 232 upward (away from knob 234) and ultimately out of the cartridge 232. For example, the cartridge 232 can have a construction such as that of cartridge 326 illustrated in FIGS. 3G-3I or cartridge 1100 in FIGS. 11A-11C.

In FIGS. 3G-3I, cartridge 326 includes an outer shell 328 that retains a queue 340 of vaporizable material therein and a feed mechanism 330 that pushes portions of the vaporizable material queue 340 out of the cartridge, in particular, by translating shuttle 332 axially within the outer shell 328. The feed mechanism 330 thus includes the shuttle 332 supported by a threaded shaft 334 coupled to a rotatable knob 336. The knob 336 is rotatably coupled to the outer shell 328 by projections 344 of the outer shell 328 that clip onto a raised shoulder 346 of knob 336. When the knob 336 is rotated, the threads of shaft 334 interact with corresponding threads on the shuttle 332 to cause the axial translation of the shuttle 332. Recesses 342 of the shuttle 332 engage projections 338 of the outer shell 328, thereby ensuring that the rotation of shaft 334 yields the desired axial translation of the shuttle 332 rather than rotation of the shuttle 332.

Similarly, in FIGS. 11A-11C, cartridge 1100 includes an outer shell 1106 that retains a queue of vaporizable material therein and a feed mechanism that pushes portions of the vaporizable material queue of the cartridge via end port 1102, in particular, by translating shuttle 1104 axially within the outer shell 1106. The feed mechanism thus includes the shuttle 1104 supported by a threaded shaft 1108 coupled to a rotatable knob 1110. The knob 1110 is rotatably coupled to the outer shell 1106 by a shoulder 1122 along the knob shaft that snaps through opening 1120 in an end surface of the outer shell 1106. When the knob 1110 is rotated, the threads of shaft 1108 cooperate with corresponding threads on the shuttle 1104 to cause the axial translation of the shuttle 1104. One or more shoulders 1114 of the shuttle 1104 abut corresponding internal shoulders 1116 of the outer shell 1106, thereby ensuring that the rotation of shaft 1108 yields the desired axial translation of the shuttle 1104 rather than rotation of the shuttle 1104. The outer shell 1106 can include an external ridge 1118 (as shown in FIG. 11C) for retaining an end cap to close the end port 1102 prior to insertion in the hopper of a personal vaporization device. The outer shell 1106 can also include one or more external projections 1112, which can be used to key an insertion orientation of the cartridge 1100 into the hopper.

Returning to FIG. 2I, with the cap 224 moved to the feed/discharge position, vaporizable material displaced from the cartridge 232 by actuation of knob 234 falls over a waterfall feed surface 226, i.e., along a feed path 210 from hopper 202 to volume 228 of the oven 206. Once full, access between the oven volume 228 and the hopper 202 is cut off by rotating the cap 224 such that a portion of cap 224 blocks vaporizable material from exiting the hopper 202, as shown in FIG. 2A. Simultaneously, the metal part 238 of cap 224 comes into contact with and compresses the vaporizable material in the oven 206. The oven 206 is then heated by the electric heating element (not shown) to generate vapors from the vaporizable material in oven volume 228, while the remaining material in hopper 202 is thermally isolated from oven 206 to preserve the material in hopper 202 for subsequent sessions.

The user inhales at mouthpiece 214, which pulls air from outside of the vaporization device 200 into the oven volume 228 via air intake 236 and the perforated bottom wall of insert 230. The inhalation further pulls the generated vapors from inside the oven volume 228 through the perforated metal part 238 of the cap 224 to the mouth of the user via inhalation flow path 212 and mouthpiece 214. A single vaporization session can include multiple inhalations (i.e., draws) by the user while heating the vaporizable material in the oven volume 228, until the vaporizable material is expended (i.e., no further vapors are generated despite further heating). Once the vaporizable material is expended (i.e., at the end of the session), the contents of the oven volume 228 are released. The cap 224 is rotated up and away from the oven 206 to allow external access to the oven volume 228, as shown in FIG. 2I. The contents of the oven 206 can be removed along discharge path 216, and a subsequent session of vaporizable material loaded from hopper 202 as described above.

Although the embodiment of FIGS. 2A-2I employs cartridge 232 inserted into hopper 202, it is also possible to load vaporizable material directly into hopper 202 without a separate cartridge 232. In such a configuration, the hopper 202 can have a translating member therein that pushes the vaporizable material out of hopper 202 to fall over waterfall feed surface 226 in order to fill the oven volume 228. The translating member can include a rotating knob at one end of the hopper 202, similar to the knob 234 of cartridge 232, or any other suitable actuation mechanism.

Referring to FIGS. 3A-3F, a second embodiment of a personal vaporization device 300 is shown. The personal vaporization device 300 has a cap 304 slidably attached to the vaporizer body 322 that allows the cap 304 to slide between feed (FIGS. 3A, 3D), vape (FIGS. 3B, 3E), and discharge (FIGS. 3C, 3F) positions. The cap 304 includes oven 306, with the volume 308 to be filled with vaporizable material being defined between a top of the oven 306 and a top surface portion 324 of the vaporizer body 322. Thus, cap 304 and top surface portion 324 can form parts of an oven assembly, wherein at least the oven 306 is movable. The cap 304 also has a portion that defines the user mouthpiece 314 as well as internal walls that define the inhalation pathway 312 between the oven 306 and the mouthpiece 314.

Hopper 302 stores a volume of vaporizable material for multiple sessions. For example, the hopper 302 can have a cartridge (e.g., cartridge 232, cartridge 326, or any other suitable cartridge) inserted therein for providing the queue of vaporizable material. Alternatively, the queue of vaporizable material can be directly loaded into the hopper 302. To initiate a particular vaporization session, the cap 304 is laterally translated to the feed position, where the internal volume 308 of the oven 306 communicates with an outlet of the hopper 302, as shown in FIGS. 3A and 3D. Vaporizable material is displaced from the hopper 302 along feed path 310 to fill volume 308 of oven 306.

Once full, access between the oven volume 308 and the hopper 302 is cut off by sliding the cap 304 to the vape position, as shown in FIGS. 3B and 3E, such that cap surface 318 blocks vaporizable material from exiting the hopper 302. Simultaneously, the top surface portion 324 of the vaporizer body 322 comes into contact with the vaporizable material in the oven 306. The oven 306 is then heated by an electric heating element (not shown) to generate vapors from the vaporizable material in oven volume 308. For example, the heating element can be wrapped around walls of oven 306 within cap 304. Power wiring can connect the heating element in the cap to a power supply within vaporizer body 322, with a length/flexibility of the cabling selected to accommodate the displacement of the cap 304 as it slides between different positions. Alternatively, the cap 304 can have contacts that engage with corresponding contacts on the vaporizer body 322 when the cap 304 is in the vaporization position, thereby allowing for powering of the heating element only when the cap is in the appropriate position. During the heating for vaporization, the remaining material in hopper 302 is thermally isolated from oven 306 to preserve the queue of material in hopper 302 for subsequent sessions.

The user inhales at mouthpiece 314, which pulls air from outside of the vaporization device 300 into the oven volume 308 via an air intake 325. In some embodiments, the top surface portion 324 of the vaporizer body 322 includes, as best seen in FIGS. 3D and 3F, a perforated metal plate disposed in correspondence with the vaporization position of the oven 306, which serves as inlet to the oven volume 308 for the external air from air intake 325. Alternatively, the air intake may be on the bottom of the vaporizer body 322, similar to the air intake 236 in the vaporization device 200 of the first embodiment. In other embodiments, there may be a slight gap between the cap 304 and the top surface portion 324, that allows air to be drawn into the oven volume 308 via the gap.

The inhalation by the user further pulls the generated vapors from inside the oven volume 308 through a wall of the oven 306 (e.g., a perforated top metal surface) to the mouth of the user via inhalation flow path 312 and mouthpiece 314. A single vaporization session can include multiple draws by the user with the cap 304 in the vape position while heating the vaporizable material in the oven volume 308. At the end of the session, the contents of the oven volume 308 are released by translating the cap 304 to the release position, as shown in FIGS. 3C and 3F. In the release position, the oven volume 308 is outside the vaporizer body 322, thereby allowing the contents of the oven to be discarded via discharge path 315. Vaporizable material for a subsequent session can then be loaded from hopper 302 by returning cap 304 to the feed position and proceeding as described above.

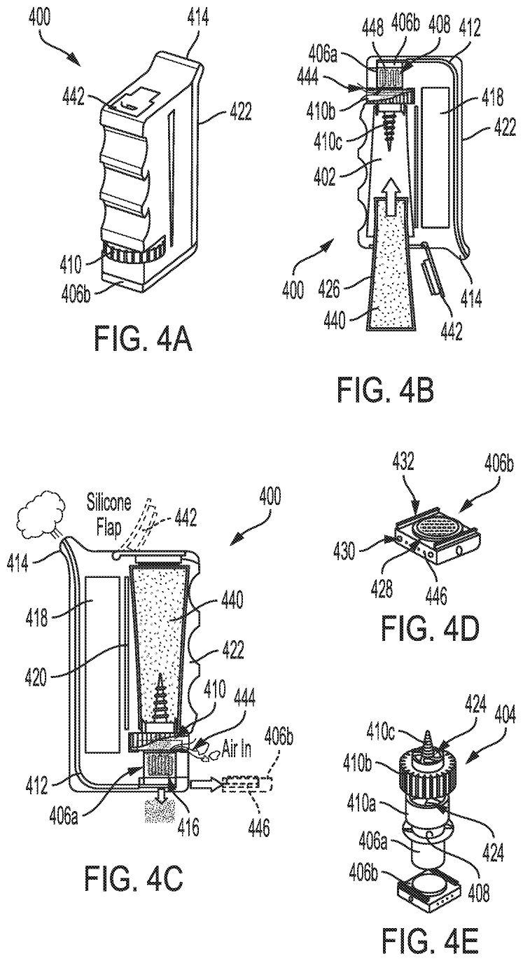

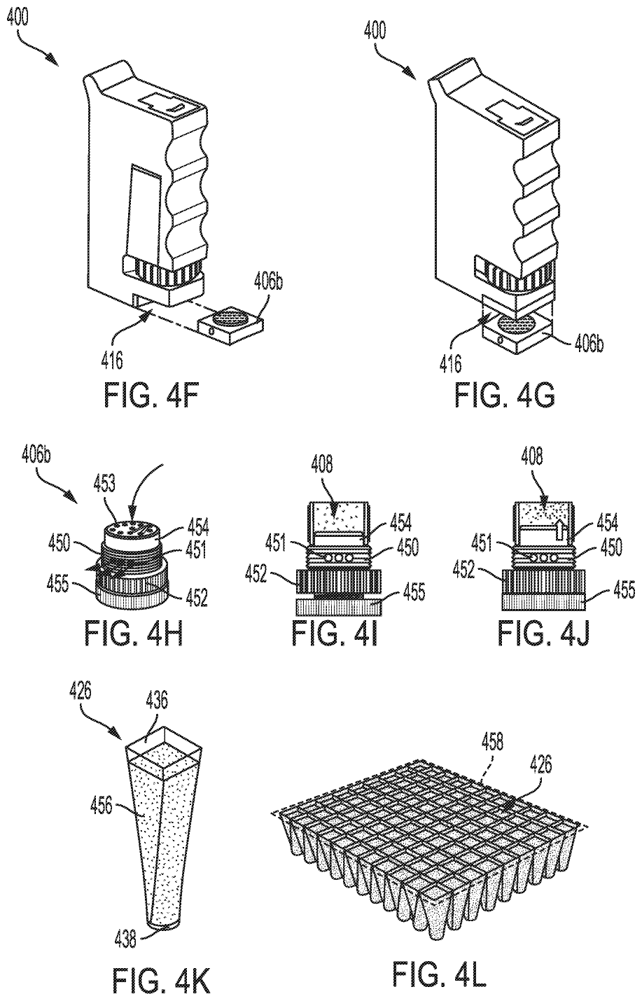

Referring to FIGS. 4A-4G, a third embodiment of a personal vaporization device 400 is shown. In contrast to the first and second embodiments, the personal vaporization device 400 has a vaporizer body 422 that defines the mouthpiece 414 and inhalation flow path 412 as well as the hopper 402. The vaporizer body 422 also supports the oven assembly 404 (with at least a first part 406a of the oven being fixed to the body 422), a power supply 418 (e.g., rechargeable battery), and control electronics/circuit board 420. The mouthpiece 414 and the oven first part 406a thus do not move with respect to the vaporizer body 422.

Hopper 402 stores vaporizable material for multiple sessions. For example, a cartridge 426 containing a premeasured supply 440 of vaporizable material can be inserted into the hopper 402 after opening a cap 442 (e.g., silicone rubber flap) covering hopper 402, as shown in FIG. 4B. To avoid spilling vaporizable material when an end of the cartridge 426 entering the hopper 402 is open, the vaporizer body 422 is inverted with respect to gravity, with the cartridge 426 being inserted upward. Once fully inserted, the vaporizer body 422 is then reoriented to an upright position as shown in FIG. 4C, such that gravity is used to feed vaporizable material from hopper 402 into the internal volume 408 of the oven.

The cartridge 426 can have a first open end 436 (fill end) and a second open end 438 (feed end) connected together by a tapering sidewall 456, as illustrated in FIG. 4K. The first open end 436 has a larger area than the second open end 438, which can assist in feeding material through the second open end 438 to the oven using only gravity. The first open end 436 has a square geometry while the second open end 438 has a substantially circular geometry. The square geometry of the first open end 436 can assist in filling multiple cartridges 426, for example, by presenting a fill surface 458 where spaces between adjacent cartridges 426 are eliminated or at least reduced, as shown in FIG. 4J. After filling, the first and second ends can be closed with respective caps (not shown). Prior to inserting the cartridge 426 into hopper 402, at least the cap covering the second end 438 is removed, allowing vaporizable material to freely leave the cartridge 426 via the second end 438.

To control access to the internal volume 408 of the oven during feed, vape, and release stages, the oven assembly 404 is provided with an inlet feed valve 410 and a removable oven base 406b (second part), as illustrated in FIGS. 4C-4E. The inlet feed valve 410 includes a valve stator 410a and a valve rotor 410b, each with a plurality of apertures 424. When the apertures 424 of the stator 410a and rotor 410b are aligned, the feed valve 410 allows access to the internal volume 408 of the oven, such that vaporizable material can be fed from the hopper 402 to the oven. The feed valve 410 can also include an auger 410c designed to agitate vaporizable material in the hopper 402 during rotation of the rotor 410b to encourage flow of material into the oven. Such a configuration may be especially useful when the flow of vaporizable material from the hopper into the oven is by force of gravity rather than a positive actuation mechanism. In a closed position of the feed valve 410, the apertures 424 of the stator 410a and rotor 410b do no overlap, such that vaporizable material cannot pass between the hopper 402 and the oven internal volume 408.

The removable oven base 406b includes a ceramic insulator ring 428 surrounding a perforated metal plate, as illustrated in FIG. 4D. A pair of rails 432 are disposed on opposite sides of the insulator ring 428 and slide into corresponding receptacles (e.g., channels) on the vaporizer body 422 to hold the oven base 406b to the first part 406a of the oven. The oven base 406b also includes a plurality of air flow paths 446 that communicate with the perforations in the metal plate and that are designed to communicate with the inhalation flow path 412 when the oven base 406b is coupled to the vaporizer body 422. The oven base 406b also has a pair of electrical contacts 430, through which electrical power can be supplied from the power supply 418 via corresponding electrical contacts of the vaporizer body 422 to the oven base 406b when coupled to the vaporized body 422. For example, the electrical power can be used to power a heating element (not shown) contained within the oven base 406b and/or to power a heating element 448 on the first part 406a of the oven via contacting surfaces between first part 406a and the oven base 406b. Thus, when the oven base 406b is removed from the vaporizer body 422, heating by the electric heating element may be avoided for added safety.

During the feed stage, the oven base 406b is retained at a bottom end of the fixed first part 406a and the vaporizer body 422. The rotor 410b of the feed valve 410 is rotated such that apertures 424 of the rotor 410b and stator 410a are aligned (or at least overlapping), thereby allowing vaporizable material from the queue 440 to flow into the oven volume 408. Once full, access between the oven volume 408 and the hopper 402 is cut off by further rotating the rotor 410b of feed valve 410 such that apertures 424 of the rotor 410b and stator 410a do not overlap with each other. The bottom of the stator 410a and the top of the oven 406a (or a member such as a disk inserted between the top of the oven and the bottom of stator 410a) can also be provided with cooperating sets of apertures similar to apertures 424 to provide further isolation between the oven and the hopper.

During the vape stage, the oven base 406b remains at a bottom end of the fixed first part while an electric heating element of the oven heats the oven volume 408 to generate vapors from the vaporizable material. The remaining material in hopper 402 is thermally isolated from the oven to preserve the queue of material in hopper 402 for subsequent sessions. The user inhales at mouthpiece 414, which pulls air from outside of the vaporization device 400 into oven volume 408 via air intake 444. The inhalation by the user further pulls the generated vapors from the oven volume 408 through a perforated surface of the oven base 406b to the mouth of the user via base air flow paths 446, inhalation flow path 412, and mouthpiece 414.

During the release stage at the end of the vaporization session, the contents of the oven volume 408 are released (unloaded or discharged) by removing the oven base 406b for example, by horizontally displacing the oven base 406b from the vaporizer body 422, as shown in FIGS. 4C and 4F, or, in an alternative arrangement, by vertically displacing the oven base 406b from the vaporizer body 422, as shown in FIG. 4G. The oven base can be magnetically attached to the body 442, thereby allowing elimination of rails 432. With the oven base 406b removed, the oven volume 408 is thus accessible, thereby allowing the contents of the oven to be discarded via discharge path 416. Vaporizable material for a subsequent session can then be loaded from hopper 402 by reattaching the oven base 406b and proceeding as described above.

Configurations for the removable oven base 406b other than the above-described horizontal or vertical translating base are also possible. For example, the removable oven base can be configured as a threaded base 406b, as illustrated in FIG. 4H, with a first part 454 having a top surface that bounds oven volume 408, a second part 450 with threads designed to screw into a threaded receptacle of the vaporizer body 422 or the fixed oven part 406a, and a knurled knob 452 that allows a user to grip and rotate the base 406b for insertion/removal. The first part 454 is coupled to and extends through the second part 450. For example, the second part 450 has a threaded through-hole, into which the first part is screwed.

The top surface of first part 454 has perforations 453 that communicate with an internal volume within or between the first and second parts. For example, the first part 454 can be hollow and have apertures in a circumferential wall that align with air outlet ports 451 of the second part 454. Air can thus be drawn from the oven volume 408 down through the perforations 453 to the intake flow path 412 via circumferential apertures of the first part 454 and the air outlet ports 451.

The oven base is preferably constructed to compress the vaporizable material within the oven volume to allow for more efficient vaporization. For example, referring to FIGS. 4H-4J, the first part 454 of the oven base 406b has its own knurled knob 455 that allows the user to change a position of the top surface of the first part 454 within the oven. At an initial loading position, illustrated in FIG. 4I, the first part 454 is rotated to at an intermediate position within the second part 450, such that knob 455 is axially displaced from the knob 452. Once the oven volume 408 has reached a desired fill level, the knob 455 can be rotated further (e.g., until it contacts knob 452), thereby advancing the top surface of the first part 454 into the oven to reduce a size of volume 408 and compress the vaporizable material therein, as illustrated in FIG. 4J. Although the configuration of FIGS. 4H-4J has been specifically discussed with respect to the third embodiment, the oven base can be adapted for use in other embodiments.

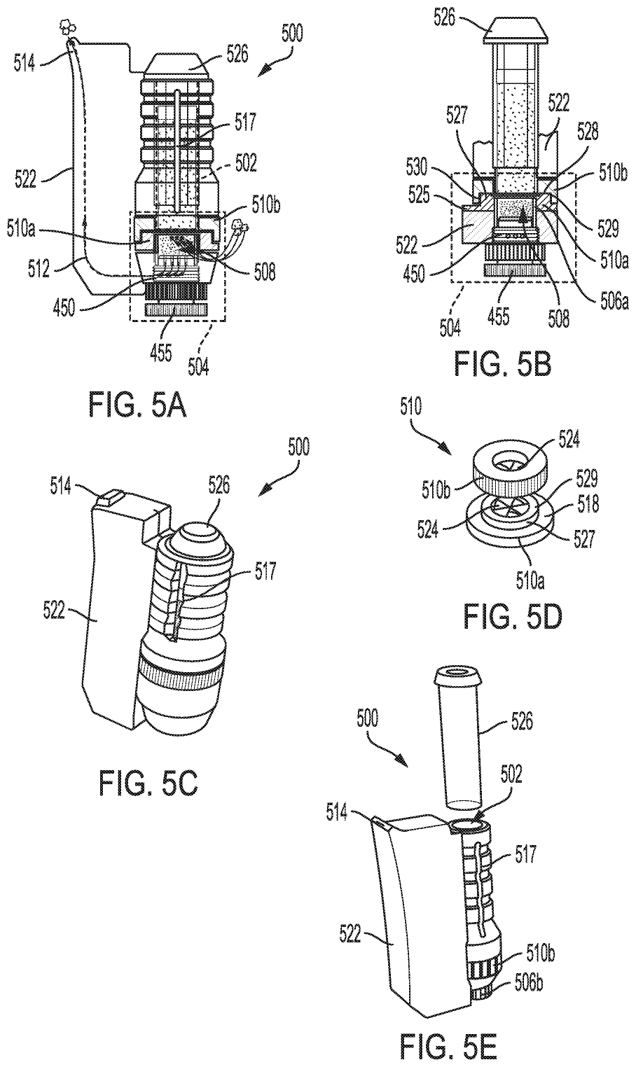

Referring to FIGS. 5A-5E, a fourth embodiment of a personal vaporization device 500 is shown. The personal vaporization device 500 has a vaporizer body 522 that defines the mouthpiece 514 and inhalation flow path as well as the hopper 502. The vaporizer body 522 also supports the oven assembly 504 (with at least a first part 506a of the oven being fixed within the body 522), a power supply, and control electronics. Similar to the third embodiment, the oven assembly 504 of the personal vaporization device 500 employs a removable oven base 506b and a feed valve 510 to control access to the internal volume 508 of the oven during the feed, vape, and release stages. The removable oven base 506b has a similar configuration to threaded base 406b illustrated in FIG. 4H.

Hopper 502 stores a vaporizable material for multiple sessions. The vaporizer body 522 has a window 517 that provides a view of the remaining amount of vaporizable material held within hopper 502. The feed of vaporizable material from the hopper 502 to the oven through the inlet feed valve 510 uses the force of gravity. For example, a cartridge 526 containing a premeasured supply of vaporizable material can be inserted into the hopper 502. The cartridge 526 can have a cap portion that sits outside of hopper 502 and abuts an upper surface of the vaporizer body 522 when the cartridge 526 is fully inserted into the hopper 502.

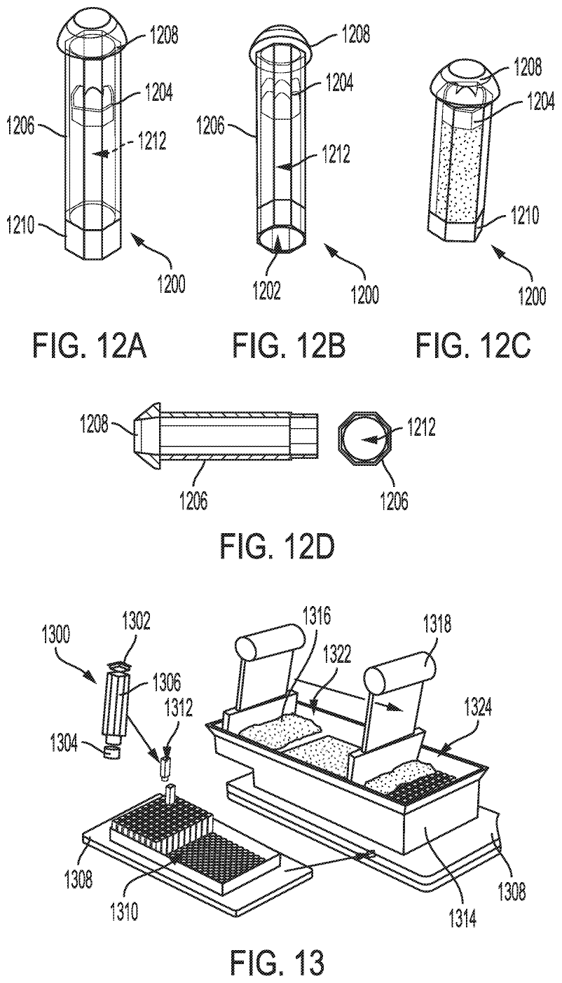

For example, the cartridge 526 can have a construction such as that of cartridge 1200 illustrated in FIGS. 12A-12D, where an outer shell 1206 retains a queue of vaporizable material in its internal volume 1212. The outer shell 1206 has a substantially octagonal cross-sectional shape, although other shapes are also possible. The cartridge 1200 includes a shuttle 1204 that pushes portions of the vaporizable material queue out of the feed port 1202, in particular, using gravity when the cartridge is oriented with the shuttle 1204 above the vaporizable material (i.e., with end cap 1208 over feed port 1202). For example, the shuttle 1204 can be weighted to apply sufficient force to the vaporizable material in order to push it through apertures of the feed valve (e.g., valve 510) when the valve is open. A removable end cap 1210 can cover the feed port 1202 prior to inserting the cartridge 1200 into the hopper to prevent inadvertent loss of material.

Returning to FIGS. 5A-5E, the inlet feed valve includes a valve stator 510a (hub) and a valve rotor 510b, each with a plurality of triangular apertures 524. The rotor 510b is rotatably held in place between an annular lip 518 of the stator 510a and a shoulder 520 of the vaporizer body 522. When the apertures 524 of the stator 510a and rotor 510b are aligned (or at least overlap), the feed valve allows access to the internal volume 508 of the oven, such that vaporizable material can be fed from the hopper 502 to the oven. In a closed position of the feed valve, the apertures 524 of the stator 510a and rotor 510b do not overlap, such that vaporizable material cannot pass between the hopper 502 and the oven internal volume 508. The valve stator 510a has a projection 525 that engages with a recess of the valve body 522 to prevent rotation of the stator 510a during actuation of the valve (i.e., when rotor 510b is rotated by a user). In the form shown, the apertures 524 of the rotor 510b are formed in a central bottom surface portion of the rotor, and the apertures 524 of the stator 510a are formed in the top surface of an upwardly projecting central portion 527 of the stator. This upwardly projecting central portion has a hollow interior that receives the top of the oven part 506a from below. The bottom central portion of the rotor is surrounded by a circumferential groove 528, and the upwardly projecting central portion 527 of the stator has a circumferential rim 529 received in the groove. A circumferential skirt portion 530 of the rotor 510b surrounds the radially outer surface of the projecting central portion 527 of the stator. With this arrangement, the surfaces of the rotor and the stator having the respective apertures 524 can be disposed in sliding contact such that when the valve is closed, the surfaces together form an effective thermal barrier between the oven and the material in the hopper.

During the feed or loading stage, the oven base 506b is screwed in at a bottom end of the fixed first part 506a and the vaporizer body 522. The rotor 510b of the feed valve is rotated such that apertures 524 of the rotor 510b and stator 510a are aligned (or at least overlapping), thereby allowing vaporizable material from the hopper 502 to flow into the oven volume 508 under the force of gravity. Once full, access between the oven volume 508 and the hopper 502 is cut off by further rotating the rotor 510b of feed valve such that apertures 524 of the rotor 510b and stator 510a do not overlap with each other.

During the vape stage, the oven base 506b remains screwed in at the bottom end of the fixed first part 506a while an electric heating element (not shown) of the oven heats the oven volume 508 to generate vapors from the vaporizable material. The remaining material in hopper 502 is thermally isolated from the oven to preserve the queue of material in hopper 502 for subsequent sessions. The user inhales at mouthpiece 514, which pulls air from outside of the vaporization device 500 into oven volume 508 via an air intake (not shown). Air may flow into the oven volume via part clearances between the oven and hub 510a, with airflow being facilitated by perforations in the sidewall of the oven if desired. The inhalation by the user further pulls the generated vapors from the oven volume 508 to the mouth of the user via oven base 506b an inhalation flow path 512 and mouthpiece 514. The air flow path into and through the oven base and to the mouthpiece would be similar to that discussed above in connection with the third embodiment.

During the release stage at the end of the vaporization session, the contents of the oven volume 508 are released (discharged) by removing the oven base 506b for example, by unscrewing the oven base 506b from the vaporizer body 522. With the oven base 506b removed, the oven volume 508 is thus accessible, thereby providing a discharge path allowing the contents of the oven to be discarded. Vaporizable material for a subsequent session can then be loaded from hopper 502 by reattaching the oven base 506b and proceeding as described above.

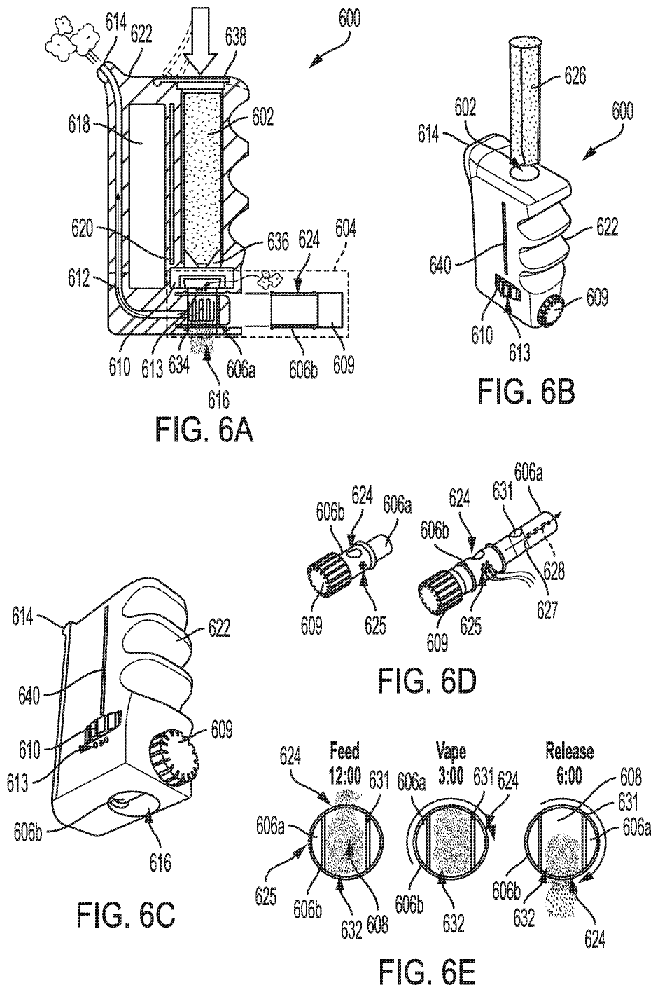

Referring to FIGS. 6A-6E, a fifth embodiment of a personal vaporization device 600 is shown. The personal vaporization device 600 has a vaporizer body 622 that defines the mouthpiece 614 and inhalation flow path 612 as well as the hopper 602. The vaporizer body 622 also supports the oven assembly 604, a power supply 618, and control electronics/circuit board 620. However, in contrast to the third and fourth embodiments, the oven assembly 604 of the personal vaporization device 600 employs a rotating oven sleeve that controls access to the internal oven volume 608 during the feed, vape, and release stages.

Hopper 602 stores a vaporizable material for multiple sessions. The vaporizer body 622 has a window 640 that provides a view of the remaining amount of vaporizable material held within hopper 602. The feed of vaporizable material from the hopper 602 to the oven through a feed valve 610 uses the force of gravity. The feed valve can have a stator/rotor arrangement with cooperative openings as previously described. The feed valve 610 can also include features designed to agitate the material within hopper 602, for example, an auger as in the third embodiment, to assist with the gravity feed of the material. Alternatively or additionally, the hopper 602 can have features therein to assist in feeding material to the oven volume 608, for example, internal funnel 636. A cartridge 626 containing a premeasured supply of vaporizable material can be inserted into the hopper 602, or the vaporizable material can be loaded directly into the hopper 602 without a separate cartridge.

The oven assembly 604 includes a fixed oven shaft 606a with an oven 631 therein thermally coupled to an electric heating element 634 (i.e., on walls of the oven 631) and a rotatable oven sleeve 606b supported on the oven shaft 606a. The oven 631 has apertures 632 on opposite circumferential sides of the shaft 606a, with the oven volume 608 being between the apertures 632. The oven sleeve 606b has a single aperture 624 on its circumference and a series of perforations 625, as shown in FIG. 6D. One of the oven openings 632 faces a feed path from hopper 602, while the other oven opening 632 faces a discharge path 616. Access to the internal volume 608 is provided by aligning (or at least overlapping) the aperture 624 with an oven opening 632. When the perforations 625 are aligned with the oven openings 632, air can flow into the oven volume 608. However, the sleeve 606b is constructed such that material can only enter or leave the oven volume 608 when the sleeve aperture 624 is overlapping with an oven opening 632.

During the feed stage, the oven sleeve 606b is rotated about the oven shaft 606a, for example, by rotating a knob 609 coupled to an end of the oven sleeve 606b, such that aperture 624 is aligned (or at least overlapping) with a first of the oven openings 632 (top opening) as shown in FIG. 6E. Vaporizable material can thus be fed via gravity from the hopper 602 into the oven volume 608 via feed valve 610. Once full, access between the oven volume 608 and the hopper 602 is cut off by further rotating the oven sleeve 606b about the oven shaft 606a such that aperture 624 does not overlap with either of the oven openings 632 and such that perforations 625 overlap with one of the oven openings 632 (top opening in FIG. 6E). For example, the aperture 624 can be at an intermediate position (e.g., 3 o'clock position) between the feed position (e.g., 12 o'clock position) and the release position (e.g., 6 o'clock position).

During the vape stage, the oven sleeve 606b remains with the aperture 624 in the non-overlapping position while an electric heating element 634 of the oven 631 heats the oven volume 608 to generate vapors from the vaporizable material. The remaining material in hopper 602 is thermally isolated from the oven to preserve the queue of material in hopper 602 for subsequent sessions. The user inhales at mouthpiece 614, which pulls air from outside of the vaporization device 600 into oven volume 608 via an air intake 613 and perforations 625. Alternatively or additionally, external air may be drawn through discharge port 616. The inhalation by the user further pulls the generated vapors from the oven volume 608 through a wall of the oven and into flow path 612 (e.g., through a hole 627 in the oven wall aligned with the end of a bore 628 in shaft 606a forming part of inhalation flow path 612) and then to mouthpiece 614.

During the release stage at the end of the vaporization session, the contents of the oven volume 608 are released by further rotating the oven sleeve 606b about the oven shaft 606a such that aperture 624 is aligned (or at least overlapping) with the oven outlet-side opening 632, bottom opening as shown in FIG. 6E. Vaporized material can thus be discharged from the oven volume 608 via discharge port 616. Vaporizable material for a subsequent vaporizing session can then be loaded from hopper 602 by reorienting the oven sleeve 606b to the feed position and proceeding as described above.

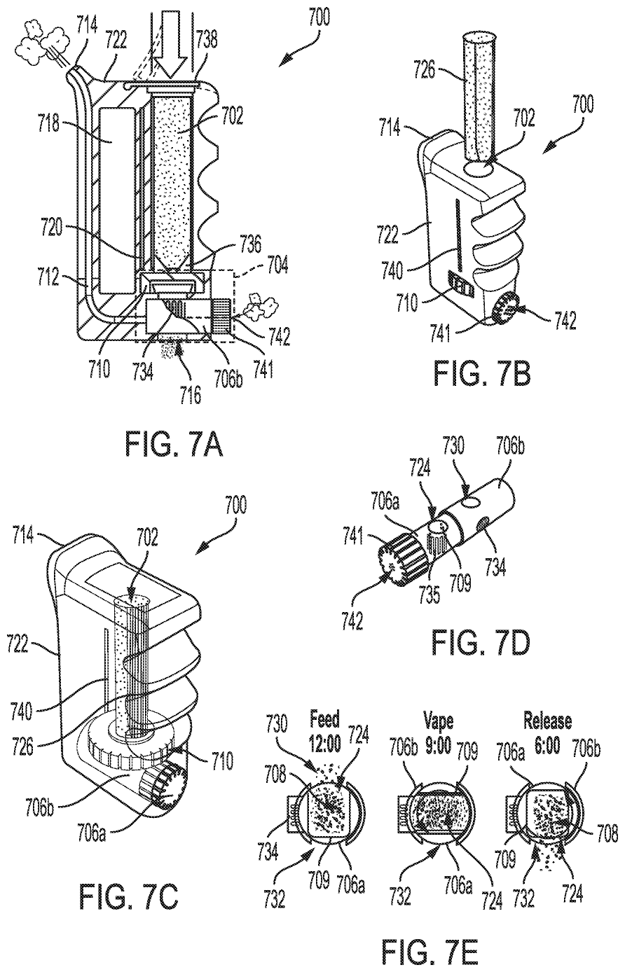

Referring to FIGS. 7A-7E, a sixth embodiment of a personal vaporization device 700 is shown. The personal vaporization device 700 has a vaporizer body 722 that defines the mouthpiece 714 and inhalation flow path 712 as well as the hopper 702. The vaporizer body 722 also supports the oven assembly 704, a power supply 718, and control electronics 720. However, in contrast to the fifth embodiment, the oven assembly 704 of the personal vaporization device 700 employs a rotating oven shaft that controls access to the internal volume 708 during the feed, vape, and release stages.

Hopper 702 stores a vaporizable material for multiple sessions. The vaporizer body 722 has a window 740 that provides a view of the remaining amount of vaporizable material held within hopper 702. The feed of vaporizable material from the hopper 702 to the oven through a feed valve 710 uses the force of gravity. The feed valve can have a stator/rotor arrangement with cooperative openings as previously described. In some embodiments, feed valve 710 can include features designed to agitate the material within hopper 702, for example, an auger as in the third embodiment, to assist with the gravity feed of the material. Alternatively or additionally, the hopper 702 can have features therein to assist in feeding material to the oven volume 708, for example, internal funnel 736. A cartridge 726 containing a premeasured supply of vaporizable material can be inserted into the hopper 702, or the vaporizable material can be loaded directly into the hopper 702 without a separate cartridge.

The oven assembly 704 includes a fixed oven sleeve 706b thermally coupled to one or more electric heating elements 734 and a rotating oven shaft 706a supported within the oven sleeve 706b. For example, the fixed oven sleeve 706b can be formed of metal and support electric heating element 734 thereon. Alternatively, the fixed oven sleeve 706b can be formed of a ceramic and support a disk-shaped electric heating element on an internal wall thereof. The rotating oven shaft 706a can be formed of ceramic and support a metal oven insert 709 therein. A separate electric heating element 735 wraps around the walls of the oven insert 709 to heat internal volume 708. Wiring within the shaft 706a can connect the heating element 735 to contacts on a surface of the shaft 706a, which contacts engage with corresponding contacts on an internal surface of the sleeve 706b when the shaft 706a is rotated to the vape position in order to provide electrical power to heating element 735. The oven sleeve 706b has an inlet 730 and an outlet 732 on opposite circumferential sides, while shaft 706a has a single aperture 724 on its circumference that communicates with the interior volume 708 of the oven insert 709, as shown in FIG. 7D. The sleeve inlet 730 faces a feed path from hopper 702, while the sleeve outlet 732 faces a discharge path 716. Access to the internal volume 708 via the sleeve inlet 730 is provided by aligning (or at least overlapping) the aperture 724 with the inlet 730. When the shaft aperture 724 is not otherwise overlapping with the sleeve inlet 730, the oven volume 708 is isolated from the feed path by the body of shaft 706a within sleeve 706b. Similarly, access to the internal volume 708 via the sleeve outlet 732 is provided by aligning (or at least overlapping) the aperture 724 with the outlet 732; otherwise, the oven volume 708 is isolated from the discharge path 716 by the body of shaft 706a within sleeve 706b.

During the feed stage, the oven shaft 706a is rotated (for example, by manually rotating knob 741 attached at one end of the oven shaft 706a) within the oven sleeve 706b such that aperture 724 is aligned (or at least overlapping) with the sleeve inlet 730, as shown in FIG. 7E. Vaporizable material can thus be fed via gravity from the hopper 702 into the oven volume 708 via feed valve 710. Access between the oven volume 708 and the hopper 702 is then cut off by further rotating the oven shaft 706a within the oven sleeve 706b such that aperture 724 does not overlap with either the sleeve inlet 730 or sleeve outlet 732. For example, the aperture 724 can be at an intermediate position (e.g., 9 o'clock position) between the inlet 730 (e.g., 12 o'clock position) and the outlet 732 (e.g., 6 o'clock position). During the vape stage, aperture 724 of oven shaft 706a can overlap with a location of electric heating element 734 of the oven sleeve 706b. Thus, material within the oven volume 708 can be heated on multiple sides, with heating element 734 providing heating adjacent to the aperture 724 and heating element 735 providing heating via at least the circumferential surface of the oven insert 735.

The heating of the oven volume 708 generates vapors from the vaporizable material. The remaining material in hopper 702 is thermally isolated from the oven to preserve the queue of material in hopper 702 for subsequent sessions. The user inhales at mouthpiece 714, which pulls air from outside of the vaporization device 700 into oven volume 708 via intake 742 in knob 741, one or more air inlet flow paths in the oven shaft 706a, and air inlet perforations in the oven insert 709. The inhalation by the user further pulls the generated vapors from the oven volume 708 through air outlet perforations opposite the air inlet perforations in the wall of the oven 709, and through one or more outlet air flow paths in the oven shaft 706a to the mouth of the user via inhalation flow path 712 and mouthpiece 714. To provide inlet and outlet flow paths, the oven shaft 706a can be hollow, and configured such that air must flow through the oven 709 to get from one end of the oven shaft to the other and thereby reach flow path 712.

During the release stage at the end of the vaporization session, the contents of the oven volume 708 can be discarded by further rotating the oven shaft 706a within the oven sleeve 706a such that aperture 724 is aligned (or at least overlapping) with the oven outlet 732, as shown in FIG. 7E. Vaporized material can thus be discharged from the oven volume 708 via discharge port 716. Vaporizable material for a subsequent session can then be loaded from hopper 702 by reorienting the oven shaft 706a to the feed position and proceeding as described above.

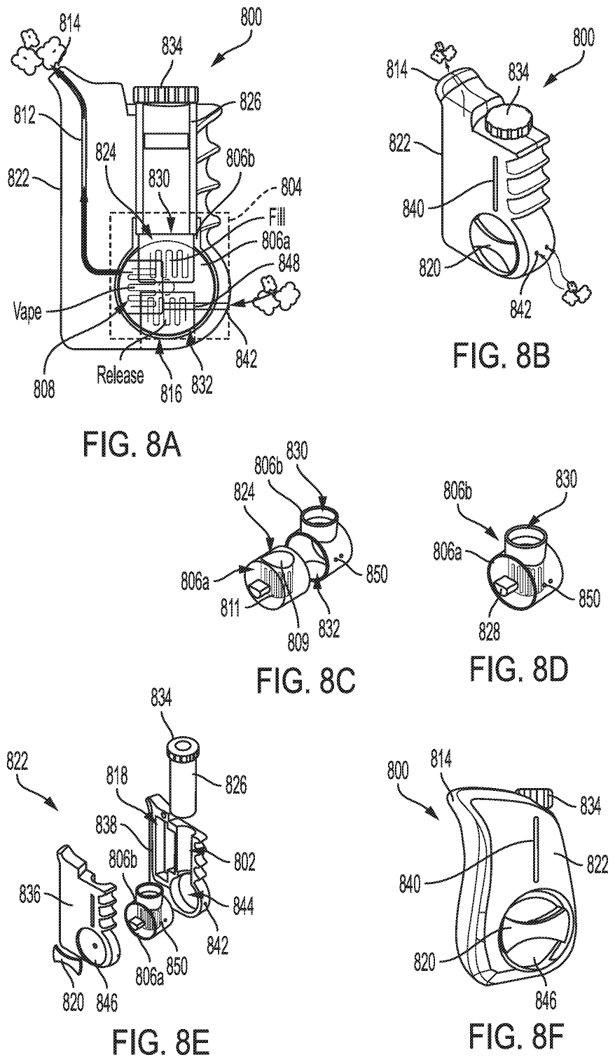

Referring to FIGS. 8A-8F, a seventh embodiment of a personal vaporization device 800 is shown. The personal vaporization device 800 has a vaporizer body 822 that defines the mouthpiece 814 and inhalation flow path 812 as well as hopper 802. For example, the vaporizer body 822 can be formed of a left half 836 and right half 838 coupled together to form a unitary body with various components contained internally. The vaporizer body 822 also supports the oven assembly 804 (e.g., in internal recess 844), a power supply (e.g., in internal recess 818), and control electronics. Similar to the sixth embodiment, the oven assembly 804 of the personal vaporization device 800 employs a rotating oven shaft 806a that controls access to the internal volume 808 during the feed, vape, and release stages.

Hopper 802 stores a vaporizable material for multiple sessions. The vaporizer body 822 has a window 840 that provides a view of the remaining amount of vaporizable material held within hopper 802. The feed of vaporizable material from the hopper 802 to the oven uses the force of gravity. A cartridge 826 containing a premeasured supply of vaporizable material can be inserted into the hopper 802, or the vaporizable material can be loaded directly into the hopper 802 without a separate cartridge. For example, the cartridge 826 can have a cap portion 834 that sits outside of hopper 802 and abuts an upper surface of the vaporizer body 822 when the cartridge 826 is fully inserted into the hopper 802.

The oven assembly 804 includes a fixed oven sleeve 806b and a rotating oven shaft 806a supported within the oven sleeve 806b. For example, the fixed oven sleeve 806b can be formed of metal. The rotating oven shaft 806a can be formed of ceramic and support a metal oven insert 809 therein. An electric heating element 811 wraps around the walls of the oven insert 809 to heat internal volume 808. Wiring within the shaft 806a can connect the heating element 811 to contacts on a surface of the shaft 806a, which contacts engage with corresponding contacts on an internal surface of the vaporizer body 822 when the shaft 806a is rotated to the vape position in order to provide electrical power to heating element 811.

The oven sleeve 806b has an inlet 830 and an outlet 832 on opposite ends, while the oven shaft 806a has a single aperture 824 on its circumference, as shown in FIG. 8C. The sleeve inlet 830 faces a feed path from hopper 802, while the sleeve outlet 832 faces a discharge path 816. The oven sleeve 806b also has a pair of air intakes 850 that communicate with respective air intakes 842 of the vaporizer body 822 to allow external air to be drawn into the oven volume 808, for example, via an appropriate air intake path 848 and/or series of perforations at a bottom surface of oven insert 809.

The oven shaft 806a has a projection 828 that interfaces with an external control dial 820. The external dial 820 rotates within a recessed surface portion 846 of the vaporizer body 822 and allows a user to select an orientation of the oven shaft 806a to coincide with a particular stage. Access to the internal volume 808 of oven insert 809 via the sleeve inlet 830 is provided by aligning (or at least overlapping) the aperture 824 with the inlet 830. When the shaft aperture 824 is not otherwise overlapping with the sleeve inlet 830, the oven volume 808 is isolated from the feed path by the body of shaft 806a within sleeve 806b. Similarly, access to the internal volume 808 via the sleeve outlet 832 is provided by aligning (or at least overlapping) the aperture 824 with the outlet 832; otherwise, the oven volume 808 is isolated from the discharge path 816 by the body of shaft 806a sleeve 806b.

During the feed stage, the oven shaft 806a is rotated (e.g., by turning control dial 820) within the oven sleeve 806b such that aperture 824 is aligned (or at least overlapping) with the sleeve inlet 830, as shown in FIG. 8A. Vaporizable material can thus be fed via gravity from the hopper 802 into the oven volume 808. Once full, access between the oven volume 808 and the hopper 802 is cut off by further rotating the oven shaft 806a within the oven sleeve 806b such that aperture 824 does not overlap with either the sleeve inlet 830 or sleeve outlet 832. For example, the aperture 824 can be at an intermediate position (e.g., 9 o'clock position) between the inlet 830 (e.g., 12 o'clock position) and the outlet 832 (e.g., 6 o'clock position).

During the vape stage, the oven shaft 806a remains with the aperture 824 in the non-overlapping position while electric heating element 811 heats the oven volume 808 of oven insert 809 to generate vapors from the vaporizable material. The remaining material in hopper 802 is thermally isolated from the oven (e.g., by the ceramic material of shaft 806a) to preserve the queue of material in hopper 802 for subsequent sessions. Moreover, the aperture 824 of the oven shaft 806a is aligned (or at least overlaps) with one or more inhalation outlets of the sleeve 806b and the inhalation flow path 812, while air intake flow paths 848 within the oven shaft 806a (and communicating with internal volume 808 via one or more perforations in a bottom wall of oven insert 809) are aligned (or at least overlap) with air intakes 842 and 850. The user inhales at mouthpiece 814, which pulls air from outside of the vaporization device 800 into oven volume 808 via air intakes 842 of the vaporization body 822, air intakes 850 in the oven sleeve 806b, and air intakes 848 in the oven shaft 806a. The inhalation by the user further pulls the generated vapors from the oven volume 808 through aperture 824 of the oven shaft 806a and an inhalation outlet of the sleeve 806b to the mouth of the user via inhalation flow path 812 and mouthpiece 814.

During the release stage at the end of the vaporization session, the contents of the oven volume 808 are released by further rotating the oven shaft 806a within the oven sleeve 806a such that aperture 824 is aligned (or at least overlapping) with the oven outlet 832, as shown in FIG. 8A. Vaporized material can thus be discharged from the oven volume 808 via discharge path 816. A subsequent session of vaporizable material can then be loaded from hopper 802 by reorienting the oven shaft 806a to the feed position and proceeding as described above.

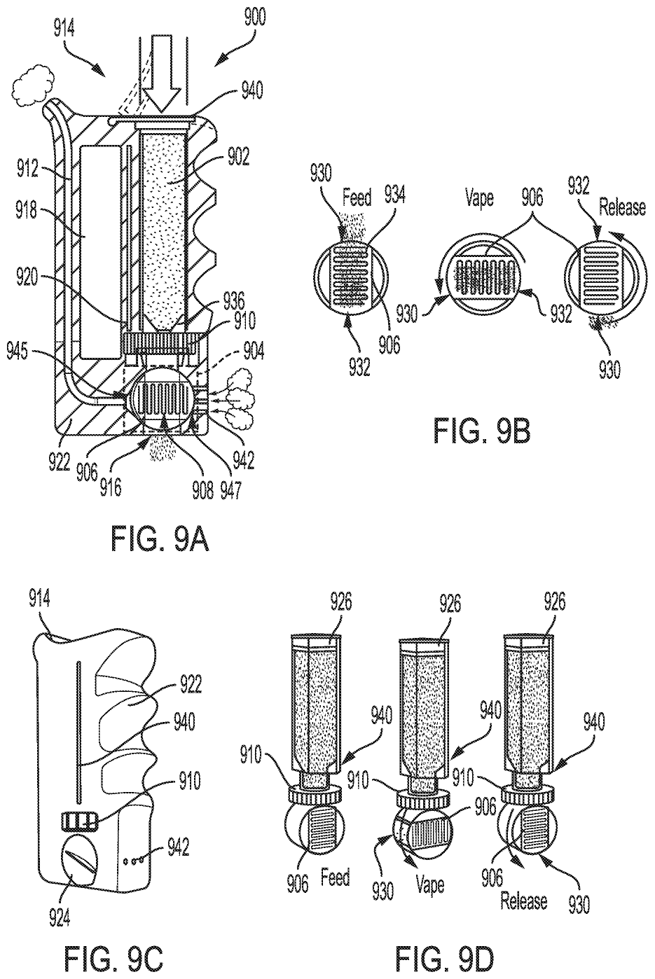

Referring to FIGS. 9A-9D, an eighth embodiment of a personal vaporization device 900 is shown. The personal vaporization device 900 has a vaporizer body 922 that defines the mouthpiece 914 and inhalation flow path 912 as well as hopper 902. The vaporizer body 922 also supports the oven assembly 904, a power supply 918 (e.g., a rechargeable battery), and control electronics 920. In contrast to the sixth and seventh embodiments, the entire oven 906 (with electric heating element 934) of the oven assembly 904 is constructed to rotate between different positions to control access to the internal volume 908 during the feed, vape, and release stages.

Hopper 902 stores a vaporizable material for multiple sessions. The vaporizer body 922 has a window 940 that provides a view of the remaining amount of vaporizable material held within hopper 902. The feed of vaporizable material from the hopper 902 to the oven through a feed wheel 910 uses the force of gravity. In some embodiments, feed wheel 910 can include features designed to agitate the material within hopper 902, for example, an auger as in the third embodiment, to assist with the gravity feed of the material. Alternatively or additionally, the hopper 902 can have features therein to assist in feeding material to the oven volume 908, for example, internal funnel 936. A cartridge 926 containing a premeasured supply of vaporizable material can be inserted into the hopper 902, or the vaporizable material can be loaded directly into the hopper 902 without a separate cartridge. In some embodiments, an internal volume of the cartridge can include features to assist in feeding material to the oven volume 908, for example, internal funnel 940 as illustrated in FIG. 9D.

The oven assembly 904 includes a rotating oven 906 having an inlet/outlet port 930 for the vaporizable material and an air intake end 932. For example, the intake end 932 may include a perforated metal surface through which air can pass. An external dial 924 can be coupled to the oven 906 and can rotate the oven 906 to different orientations to allow access to the oven volume 908 by different parts of the vaporization device 900. Thus, during the feed stage, the oven 906 is rotated such that the aperture 930 is aligned (or at least overlapping) with a feed path from the hopper 902, as shown in FIGS. 9B and 9D. Vaporizable material can thus be fed via gravity from the hopper 902 into the oven volume 908 via feed wheel 910. Once full (for example, as indicated by monitoring an amount of material dispensed via viewing window 940), access between the oven volume 908 and the hopper 902 is cut off by further rotating the oven 906 such that inlet/outlet port 930 does not overlap with either the feed path or the discharge path 916. For example, the inlet/outlet port 930 can be at an intermediate position (e.g., 9 o'clock position) between the feed path (e.g., 12 o'clock position) and the discharge path (e.g., 6 o'clock position).

During the vape stage, the oven 906 remains with the inlet/outlet port 930 in the non-overlapping position while electric heating element 934 heats the oven volume 908 to generate vapors from the vaporizable material. The remaining material in hopper 902 is thermally isolated from the oven 906 (for example, by ceramic material surrounding the oven 906) to preserve the queue of material in hopper 902 for subsequent sessions. Moreover, the inlet/outlet port 930 of the oven 906 is aligned (or at least overlaps) with an inlet 945 to the inhalation flow path 912, while perforations in surface 932 of the oven 906 communicate with air intakes 942. Screens or other structures that allow air or vapors to pass therethrough while retaining vaporizable material within the oven volume 908 may be disposed on either side of the oven 906, for example at inlet face 945 and outlet face 947 of air intakes 942.

The user inhales at mouthpiece 914, which pulls air from outside of the vaporization device 900 into oven volume 908 via air intakes 942 of the vaporization body 922 and perforations of oven surface 932. The inhalation by the user further pulls the generated vapors from the oven volume 908 through inlet/outlet port 930 of the oven 960 to the mouth of the user via inhalation flow path 912 and mouthpiece 914.

During the release stage at the end of the vaporization session, the contents of the oven volume 908 are released by further rotating the oven 906 such that inlet/outlet port 930 is aligned (or at least overlapping) with the discharge path 916, as shown in FIGS. 9B and 9D. Vaporized material can thus be discharged from the oven volume 908 via discharge path 916. Vaporizable material for a subsequent session can then be loaded from hopper 902 by reorienting the oven 906 to the feed position and proceeding as described above.

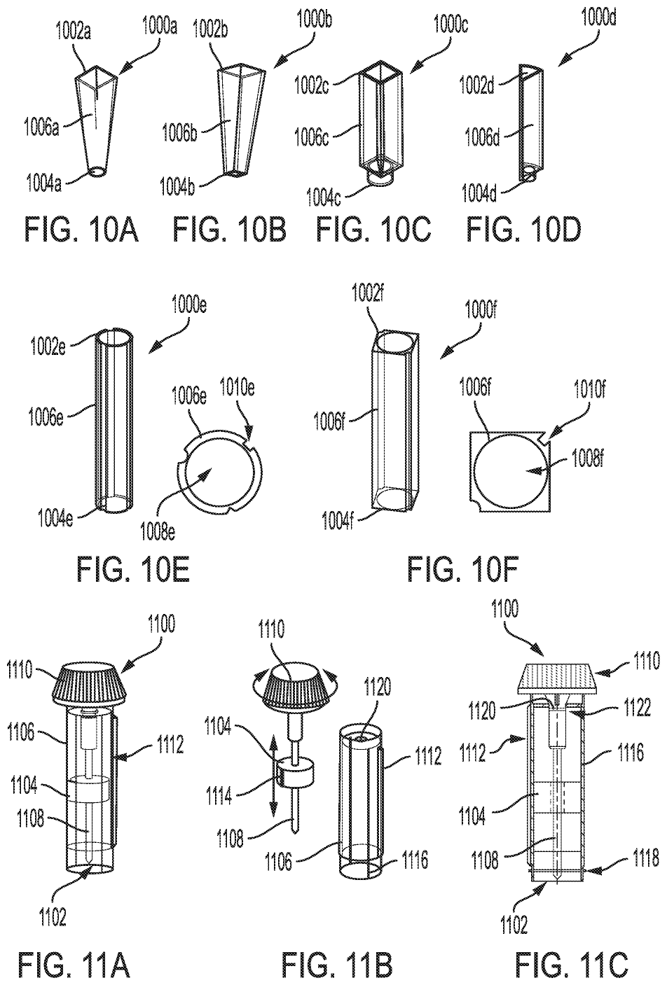

Although particular configurations for cartridges to be used with the disclosed personal vaporization devices are discussed above, embodiments of the disclosed subject matter are not limited thereto. For example, in FIG. 10A, cartridge 1000a has a square fill port 1002a (where vaporizable material is loaded into the cartridge), a circular feed port 1004a (where vaporizable material is dispensed from the cartridge to the oven), and a tapered sidewall connecting the two ports. In another variation illustrated in FIG. 10B, cartridge 1000b has a square fill port 1002b, a feed port 1004b, and a tapered sidewall 1006b connecting the two. For feed port 1004b, an external profile thereof has a square shape while an internal profile thereof has a circular shape. In another variation illustrated in FIG. 10C, cartridge 1000c has a square fill port 1002c, a circular feed port 1004c, and a stepped sidewall 1006c connecting the two. In another variation illustrated in FIG. 10D, cartridge 1000d has a triangular fill port 1002d, a circular feed port 1004d, and a stepped sidewall 1006d connecting the two.

Although FIGS. 10A-10D illustrate cartridges that have internal cross-dimensions that vary along the axial direction (i.e., where the internal volume has a cross-sectional area proximal to the fill port greater than a cross-sectional area proximal to the feed port), it is also possible for the cross-dimensions to remain constant. For example, in FIG. 10E, cartridge 1000e has a circular fill port 1002e, a circular feed port 1004e, and a straight sidewall 1006e connecting the two. In another variation illustrated in FIG. 10F, cartridge 1000f has a fill port 1002f with a circular internal profile and a square external profile, a feed port 1004f with the same circular internal profile and square external profile, and a straight sidewall 1006f connecting the two. Thus, the internal volume 1008e/1008f has a constant cross-section along the length of the cartridge 1000e/1000f. The sidewall 1006e or 1006f can also include one or more recesses 1010e/1010f or projections that can act as a key when inserting the cartridge into the hopper of the vaporization device (e.g., to prevent unauthorized cartridges from being inserted into the hopper).

Other variations beyond those described above are also possible. Indeed, the geometry and construction of the cartridge may be selected based on considerations including, but not limited to, method of loading the cartridge with vaporizable material, hopper geometry, and vaporizable material feed method (e.g., gravity feed versus active dispensing of vaporizable material to the oven). For example, when loading multiple cartridges at once, it can be beneficial to array the cartridges together with minimal or no spacing between adjacent fill ports to avoid losing vaporizable material between the cartridges. See, for example, FIG. 4L.

FIG. 13 illustrates an exemplary configuration of a station or system for simultaneously filling multiple cartridges. The cartridge 1306 of cartridge assembly 1300 is similar to the cartridge illustrated in FIG. 10C, although other configurations are also possible. When fully assembled, cartridge assembly 1300 includes a fill cap 1302 that closes the fill port 1312 and a feed cap 1304 that closes the feed port. During loading with vaporizable material, the fill cap 1302 is removed, while the feed cap 1304 remains in place until the cartridge 1306 is ready for loading in the hopper of the vaporizer device.

A cartridge holding portion, such as an alignment tray 1308 has a plurality of receptacles 1310, preferably in a two-dimensional array. Each receptacle 1310 supports a respective cartridge assembly 1300 therein. The external cartridge shape at the fill ports 1312 and the spacing of the receptacles 1310 of the alignment tray 1308 are such that there are no gaps or minimal gaps between fill ports of adjacent cartridges. Once the tray 1308 is fully loaded, a material supply holding portion, a fill tray 1314 in the form shown, is disposed over the alignment tray 1308. Vaporizable material 1316 to be filled into the cartridges is then swept from loading ramp 1322 to the respective fill ports 1312 in loading area 1324. A screed paddle 1318 can be used to help push the vaporizable material into the cartridges. Since there is no (or minimal) space between adjacent cartridges at the feed ports, all of the vaporizable material swept into the loading area 1324 will be pushed into the cartridges by the screed paddle 1318.

In any of the disclosed embodiments employing a cartridge for loading the hopper, the vaporization device and the cartridge may interact with each other to releasably retain the cartridge within the hopper. For example, external ridge 1118 of cartridge 1100 may snap-fit into an appropriate receptacle on the hopper. Alternatively or additionally, magnets within one of the vaporization device and the cartridge may attract magnets of opposite polarity or appropriate metal parts in the other of the vaporization device and the cartridge.

Although the description above is focused on the use of a cartridge of vaporizable material inserted into the hopper of the vaporization device, it should be emphasized that the disclosed embodiments are not required to use a cartridge. Rather, vaporizable material can be directly loaded into the hopper without the use of a cartridge in any of the disclosed embodiments, with appropriate modification when necessary to include an appropriate feed mechanism.

Although not specifically mentioned in the description of embodiments above, any of the disclosed oven assemblies can include features that prevent vaporizable material from inadvertently leaving the oven volume during inhalation by the user. For example, inlet or outlet ports or air flow paths leading to or from the oven internal volume can include respective meshes or screens to retain vaporizable material within the oven despite the air flow.

In this application, unless specifically stated otherwise, the use of the singular includes the plural and the use of “or” means “and/or.” Furthermore, use of the terms “including” or “having,” as well as other forms, such as “includes,” “included,” “has,” or “had” is not limiting. Any range described herein will be understood to include the endpoints and all values between the endpoints.

It is thus apparent that, beyond the example vaporizer devices shown here, many alternatives, modifications, and variations are enabled by the present disclosure. While specific examples have been shown and described in detail to illustrate the application of the principles of the present invention, it will be understood that the invention may be embodied otherwise without departing from such principles. For example, disclosed features may be combined, rearranged, omitted, etc. to produce additional embodiments, while certain disclosed features may sometimes be used to advantage without a corresponding use of other features. Accordingly, Applicant intends to embrace all such alternative, modifications, equivalents, and variations that are within the spirit and scope of the present invention.

1. A personal vaporization device, comprising:
an oven assembly comprising an oven for holding non-liquid vaporizable material for a vaporizing session, and an electric heating element thermally coupled to the oven to heat the vaporizable material in the oven;
an air flow path through which a user inhales vapors generated by heating the vaporizable material in the oven;
a hopper for holding a supply of the vaporizable material for at least one additional vaporizing session; and
a feed path by way of which the vaporizable material can be fed from the hopper to the oven.

2. The personal vaporization device of claim 1, wherein a volume of the hopper is sufficiently greater than a volume of the oven for the hopper to provide vaporizable material for multiple vaporizing sessions to the oven.

3. The personal vaporization device of claim 1, wherein the oven assembly comprises a movable portion arranged to control access to the oven via the feed path.

4. The personal vaporization device of claim 3, wherein the movable portion includes a feed valve disposed in the feed path.

5. The personal vaporization device of claim 3, wherein the movable portion includes a member rotatable to a position allowing access to the oven via the feed path and a position preventing such access.

6. The personal vaporization device of claim 5, wherein the oven is disposed in a shaft, and the rotatable member includes a sleeve rotatable about the shaft, a wall of the sleeve having an opening that can be positioned to communicate with an inlet opening of the oven and positioned away from the inlet opening such that the inlet opening is blocked by the wall of the sleeve.

7. The personal vaporization device of claim 6, wherein the opening in the wall of the sleeve can be positioned to communicate with an outlet opening of the oven such that, after a vaporizing session, used material can be removed from the oven through the opening in the wall of the sleeve.

8. The personal vaporization device of claim 5, wherein the oven is disposed in a shaft surrounded by a sleeve, the rotatable member includes the shaft, the shaft being rotatable within the sleeve to a position at which an inlet opening of the oven communicates with an opening in a wall of the sleeve and a position at which the inlet opening of the oven is blocked by the wall of the sleeve.

9. The personal vaporization device of claim 8, wherein the shaft is further rotatable within the sleeve to a position at which the inlet opening of the oven communicates with a second opening in the wall of the sleeve such that, after a vaporizing session, used material can be removed from the oven through the inlet opening and the second opening in the wall of the sleeve.

10. The personal vaporization device of claim 5, wherein the oven is disposed in the rotatable member, the rotatable member being rotatable to a position at which an inlet opening of the oven communicates with the feed path and a position at which the inlet opening of the oven does not communicate with the feed path.

11. The personal vaporization device of claim 10, wherein the rotatable member is further rotatable to a position at which the inlet opening of the oven communicates with a discharge path such that, after a vaporizing session, used material can be discharged from the oven through the inlet opening.

12. The personal vaporization device of claim 3, wherein the movable portion includes a pivoting cap, and the feed path comprises a sloping wall extending from a top portion of the hopper to the oven.

13. The personal vaporization device of claim 12, wherein a part of the pivoting cap forms a top wall of the oven during vaporization of the material in the oven.

14. The personal vaporization device of claim 13, wherein the pivoting cap includes a mouthpiece for drawing vapors via the air flow path.

15. The personal vaporization device of claim 3, wherein the movable member includes a slidable cap, the oven is disposed in the cap, and the cap is slidable to a loading position at which an inlet opening of the oven communicates with an outlet of the hopper, and a vaping position at which the oven does not communicate with the outlet of the hopper and the material in the oven is vaporized.

16. The personal vaporization device of claim 15, wherein the cap is further slidable to a position at which the inlet opening of the oven communicates with a discharge path such that, after a vaporizing session, used material can be discharged from the oven through the inlet opening.

17. The personal vaporization device of claim 3, wherein the oven assembly comprises a movable portion arranged to control access to the oven via a discharge path for removing used material from the oven.

18. The personal vaporization device of claim 17, wherein the movable portion arranged to control access to the oven via the discharge path is the same as the movable portion arranged to control access to the oven via the feed path.

19. The personal vaporization device of claim 17, wherein the movable portion arranged to control access to the oven via the discharge path comprises a removable portion of the oven assembly.

20. The personal vaporization device of claim 19, wherein the removable portion of the oven assembly includes an oven base.

21. The personal vaporization device of claim 20, wherein the oven base has a portion that compresses material in the oven during vaporization.

22. The personal vaporization device of claim 3, wherein the movable portion of the oven assembly includes a member movable between:
a feed position to allow loading of vaporizable material from the hopper to the oven via the feed path;
a vape position where the feed path from the hopper to the oven is closed; and
a release position where the oven is open to allow discharge of used material therefrom.

23. The personal vaporization device of claim 22, wherein the feed position and the release position are the same.

24. The personal vaporization device of claim 22, wherein:
the movable member comprises an oven sleeve with an aperture on its circumference;
the oven is provided in a fixed shaft disposed within the sleeve and has first and second openings at different circumferential positions of the shaft;
the oven sleeve is constructed to rotate around the oven to move between the feed, vape, and release positions;
in the feed position, the aperture of the oven sleeve communicates with the first opening of the oven for loading the oven through the aperture and the first opening;
in the vape position, the aperture of the oven sleeve is isolated from both the first and second openings of the oven; and
in the release position, the aperture of the oven sleeve communicates with the second opening of the oven for removing used material from the oven through the second opening and the aperture.

25. The personal vaporization device of claim 22, wherein:
the movable member comprises a rotatable shaft provided with the oven, the rotatable shaft having an aperture on its circumference to provide access to the oven;
the electric heating element is supported on a fixed sleeve which has first and second openings on its circumference;
the rotatable shaft is arranged to rotate within the fixed sleeve to move between the feed, vape, and release positions;
in the feed position, the aperture of the rotatable shaft communicates with the first opening of the fixed sleeve for loading the oven through the first opening and the aperture;
in the vape position, the aperture of the rotatable shaft is isolated from both the first and second openings of the fixed sleeve; and
in the release position, the aperture of the rotatable shaft communicates with the second opening of the fixed sleeve for removing used material from the oven through the aperture and the second opening.

26. The personal vaporization device of claim 25, wherein the rotatable shaft has an end cap at a longitudinal end thereof, the end cap including an intake through which air can be drawn into the oven by inhalation by the user.

27. The personal vaporization device of claim 25, wherein:
the fixed sleeve includes an air intake through which air can be drawn into the oven by inhalation by the user, and
in the vape position, the aperture of the rotatable shaft communicates with the air intake of the fixed sleeve.

28. The personal vaporization device of claim 22, wherein:
the movable member is a rotatable member comprising the oven, which has an opening at one end;
the electric heating element is supported by and moves with the oven;
the rotatable member rotates the oven between the feed, vape, and release positions
in the feed position, the opening of the oven is positioned to receive material from the hopper for loading the oven;
in the vape position, the opening of the oven is isolated from the hopper; and
in the release position, the opening of the oven communicates with a discharge opening for removing used material from the oven through the oven opening and the discharge opening.

29. The personal vaporization device of claim 1, further comprising:
a body that defines at least the hopper and the air flow path,
wherein the body comprises a first portion and a second portion joined together, and
the oven assembly is supported between the first and second portions.

30. The personal vaporization device of claim 4, wherein the feed valve includes a first valve member having a plurality of first openings, and a second valve member having a plurality of second openings and rotatable relative to the first valve member, such that the first and second openings can be at least partially overlapped to permit vaporizable material to flow from the hopper through the feed valve for delivery to the oven, and such that the first and second openings can be non-overlapped so as to block material flow from the hopper through the feed valve.

31. The personal vaporization device of claim 4, wherein the feed valve is integrated with an agitating auger that extends into the hopper.

32. The personal vaporization device of claim 2, further comprising a translating member that displaces to push a portion of the vaporizable material out of the hopper to load the oven.

33. The personal vaporization device of claim 1, further comprising control electronics operatively coupled to the electric heating element and configured to control a temperature thereof.

34. The personal vaporization device of claim 33, further comprising a power supply that provides electrical power to the control electronics and/or the electric heating element.

35. The personal vaporization device of claim 34, wherein the power supply comprises a rechargeable battery.

36-45. (canceled)
